(19) United States
(12) Patent Application Publication
(10) Pub. No.: US 2008/0296084 A1
(43) Pub. Date: Dec. 4, 2008

(54) Vehicle Steering System and Method For Controlling a Vehicle Steering System

(75) Inventors: Jurgen Bohm, Oberneisen (DE); Steffen Linkenbach, Eschborn (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 11/667,389

(22) PCT Filed: Nov. 4, 2005
(86) PCT No.: PCT/EP2005/055904

§ 371 Date: Aug. 13, 2008

(30) Foreign Application Priority Data
Nov. 11, 2004 (DE) 102004054616.9

(51) Int. Cl. B62D 5/06; G06F 19/00

(52) U.S. Cl. 180/441; 701/41

(57) ABSTRACT

Disclosed is a vehicle steering system for motor vehicles with a steering handle operable by the driver and connected to steerable vehicle wheels in terms of effect in order to determine a direction of driving. The vehicle steering system includes a hydraulic working cylinder having two directions of effect, as well as a hydraulic pressure source, which applies hydraulic pressure to a valve assembly. The valve assembly controls the magnitude of the hydraulic pressure conveyed to the working cylinder and determines the direction of effect of the working cylinder. The valve assembly includes a slide valve, which is actuated by an actuator and associated with which are a pressure sensor and a travel sensor, whose signal outlets are connected to a pressure controller or a travel controller in terms of signals. The output quantity of the pressure controller and the travel controller can be sent to an evaluating circuit, which links the output quantities to weighting factors in order to determine a controlled quantity of the actuator.

### BACKGROUND OF THE INVENTION

The present invention relates to a vehicle steering system and a method of controlling a vehicle steering system.

Up-to-date motor vehicles, especially passenger vehicles, are generally equipped with hydraulic or electrohydraulic power steering systems, in which a steering wheel is forcedly coupled mechanically to the steerable vehicle wheels. The servo aid of the vehicle steering system usually includes one or more actuators such as hydraulic cylinders in the mid-portion of the steering mechanism. A force generated by the actuators supports the operation of the steering mechanism as a reaction to the rotation of the steering wheel induced by the driver. This reduces the expenditure of force of the driver during the steering operation.

Hydraulic vehicle steering systems known in the art are hydraulic power steering systems according to the open-center principle wherein, in the straight-ahead position of the steering wheel, substantially no pressure difference prevails between the cylinder chambers of a hydraulic working cylinder being separated by a piston. In steering systems of this type, a steering movement of the driver is evaluated in terms of the steering angle and the steering torque. Depending thereon, a corresponding servo pressure is adjusted by means of an electromotively or electromagnetically driven slide valve and is delivered to a cylinder chamber of the hydraulic cylinder, in order to produce the desired steering aid.

An object of the invention involves providing a vehicle steering system of the mentioned type, which exhibits an improved meterability.

### SUMMARY OF THE INVENTION

This object is achieved by a vehicle steering system. In particular, the invention discloses a vehicle steering system for motor vehicles with a steering handle operable by the driver and connected to steerable vehicle wheels in terms of effect to determine a direction of driving. The vehicle steering system comprises a hydraulic working cylinder having two directions of effect, and a hydraulic pressure source, which applies hydraulic pressure to a valve assembly. The valve assembly controls the magnitude of the hydraulic pressure conveyed to the working cylinder and determines the direction of effect of the working cylinder. According to the invention, the valve assembly includes a slide valve, which is actuated by an actuator and associated with which are a pressure sensor and a travel sensor, whose signal outlets are connected to a pressure controller or a travel controller in terms of signals. The output quantity of the pressure controller and the travel controller, respectively, can be sent to an evaluating circuit, which links the output quantities to weighting factors in order to determine a controlled quantity of the actuator.

In a specific embodiment of the invention, the actuator is an electromagnetic or an electromotive actuator.

Another objective of the invention relates to providing a method of controlling a vehicle steering system, the use of which allows an improved meterability of the vehicle steering system.

This object is achieved by a control method. The invention discloses a method of controlling a hydraulic vehicle steering system, wherein the servo pressure is adjusted during a steering movement by means of an electromotively or electromagnetically driven valve. The method of the invention comprises the. following steps:
detecting the instantaneous pressures in cylinder chambers of a working cylinder;
detecting the position of a control member for adjusting the servo pressure;
determining an actuation parameter for the control member on the basis of the detected pressure and a nominal servo pressure;
determining an actuation parameter for the control member on the basis of the detected position of the control member and a nominal value for the position of the control member;
defining weighting factors for the actuation parameters as a function of the nominal servo pressure, and
calculating a joint actuation parameter from the weighted actuation parameters.

In an expedient improvement of the method of the invention, the weighting factors are set in such a manner in the presence of low servo pressures that the actuation parameter, which has been found based on the detected position of the control member, dominates the joint actuation parameter.

In another expedient improvement of the method of the invention, the weighting factors are adjusted in such a fashion in the presence of servo pressures that the actuation parameter, which was detected on the basis of the nominal servo pressure, dominates the joint actuation parameter.

Advantageously, the weighting factors in the intervals can range from 0 to 1. The sum of the weighting factors can equal 1 in another embodiment of the invention.

Favorably, a nominal torque for the hydraulic vehicle steering system can be calculated from commands of the driver.

In an advantageous improvement of the invention, the output signals of driver assist systems are superposed on the driver's commands. It can be arranged for in this case that the output signals of driver assist systems are additively superposed on the driver's commands. It can be provided in another development that the output signals of driver assist systems are superposed on the driver's commands with a weighting factor.

One embodiment of the invention is illustrated in the drawings. Like or corresponding parts have been designated by identical reference numerals in the different Figures of the drawings.

### BRIEF DESCRIPTION OF THE DRAWINGS

In the accompanying drawings:

FIG. 1 is a principle view of the overall system of a vehicle steering system of the invention;

FIG. 2 shows a section of the vehicle steering system of FIG. 1;

FIG. 3 shows a schematic action chart of the vehicle steering system of FIG. 1;

FIG. 4 shows the static characteristic curve of a slide valve for controlling the working pressure;

FIG. 5 shows a schematic diagram to illustrate the actuator control;

FIG. 6 shows a schematic action chart of the vehicle steering system with overriding steering interventions;

FIG. 7 shows a schematic action chart of the vehicle steering system in consideration of external controlling interventions; and

FIG. 8 shows another action chart of the vehicle steering system in consideration of overriding steering interventions and external controlling interventions.

### DETAILED DESCRIPTION OF THE DRAWINGS

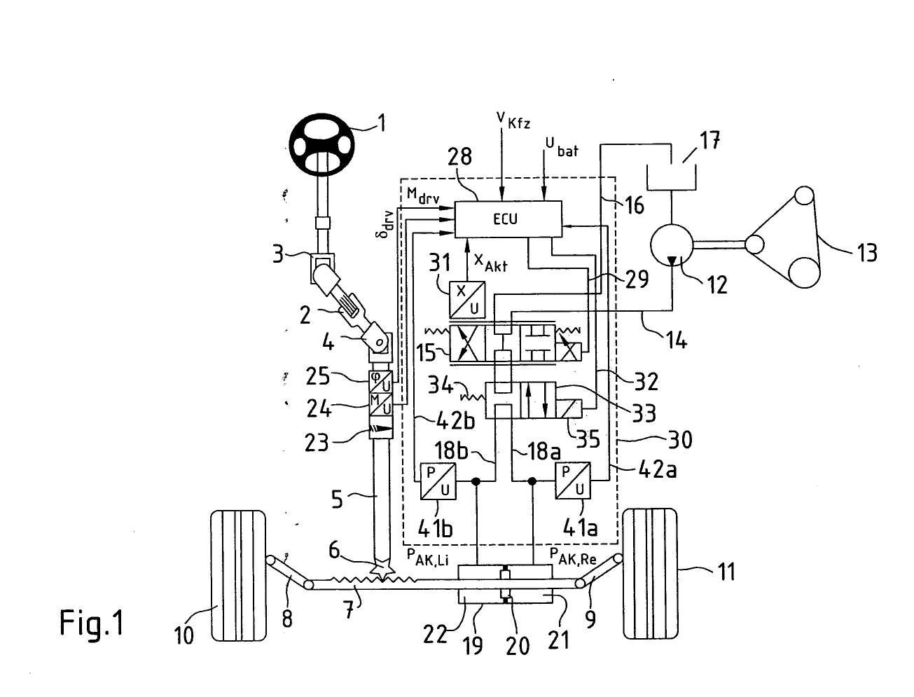

FIG. 1 shows a basic diagram of an embodiment of the vehicle steering system of the invention. Beside the schematic design of the vehicle steering system relating to apparatus, sensor information is shown as well, being required to realize the functions of the vehicle steering system of the invention.

The steering system illustrated in FIG. 1 comprises a steering wheel 1 and a steering column 2, which is connected to the steering wheel 1 and has two universal joints 3, 4. The steering column 2 is connected to a steering wheel shaft 5 or forms part of the steering wheel shaft 5. The steering wheel shaft 5 drives a steering gear 6, converting the rotation of the steering wheel shaft 5 into a translational motion of a steering rod 7. In FIG. 1, the steering rod 7 is configured as toothed rack 7 that operates the tie rods 8, 9 arranged at the steering rod 7. The actuation of the tie rods 8, 9 causes wheels 10, 11 to deviate in order to steer the direction of travel of the vehicle. In the rack-and-pinion steering system (as shown herein), hydraulic aid is realized by means of a hydraulic pump 12 that is driven by means of the driving motor of the vehicle. Pump 12 is driven by way of a belt drive 13 in the illustrated embodiment. Of course, all other appropriate driving means known from the state of the art are feasible in order to realize the invention at issue. Hydraulic pump 12 produces pressure in a hydraulic fluid, which is fed through a conduit 14 to a directional control valve 15. The pressure fluid can flow back into a supply reservoir 17 by way of a return conduit 16. The directional control valve 15 is connected to a hydraulic working cylinder 19 by way of two hydraulic conduits 18a, 18b. A piston 20 subdivides the hydraulic cylinder 19 into two cylinder chambers 21, 22. Piston 20 is immovably seated on the steering rod 7 so that the piston 20 can exert a force directly to the steering rod 7 when excess pressure is applied to one of the two cylinder chambers 21, 22.

A torsion rod 23, a torque sensor 24, and an angle sensor 25 are arranged between the second universal joint 4 and the steering gear 6. The angle sensor 25 measures the angle of rotation predetermined by a driver using the steering wheel 1 and outputs an output signal δ_{DRV} being representative of the angle of rotation. The output signal δ_{DRV} is transmitted to a control unit (ECU) 28 in order to drive the directional control valve 15.

The angle sensor 25 e.g. concerns the angle sensor, which is used in systems for driving dynamics control, for example in an ESP system (ESP: Electronic Stability Program), in order to find out the steering specification of the driver, which is usually taken into account in such systems in order to determine a desired performance of the vehicle. The output signal δ_{DRV} is transmitted to the control unit 28 preferably by way of a data bus in the vehicle, preferably by way of the CAN bus (CAN: Controller Area Network) that is usually employed in motor vehicles.

The torque sensor 24 measures the torque exerted by the driver and sends an output signal δ_{DRV} that is representative of the torque to the control unit 28.

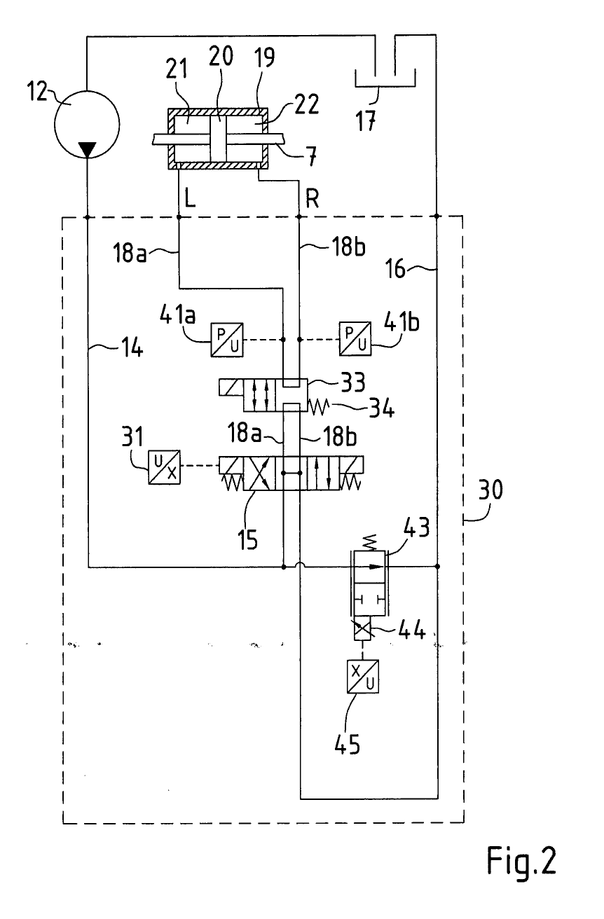

A control conduit 29 leads from the control unit 28 to the directional control valve 15 in order to determine the direction of the steering aid, that means, which one of the two cylinder chambers 21, 22 is acted upon by the pressure fluid. A travel sensor 31 measures the position of the slide in the directional control valve 15, and the output signal x_{Akt} of the sensor is fed back to the control unit 28 in order to close a control circuit. In addition, a slide valve 43 (FIG. 2), which is not shown in FIG. 1, determines the magnitude of the working pressure, that means the rate of the steering aid.

A second control conduit 32 connects the control unit 28 to a safety valve 33. In the event of system failure, the safety valve 33 establishes a hydraulic short-circuit between the two cylinder chambers 21, 22 of the working cylinder 19. This fact safeguards that the vehicle remains steerable due to the mechanical coupling between the steering wheel 1 and the steering rod 7. The hydraulic short-circuit between the cylinder chambers 21, 22 ensures that the piston 20 and, thus, the steering rod is displaceable.

The safety valve 33 is configured in such a way that it is preloaded by a mechanical spring 34 to adopt the short-circuit position shown in FIG. 1. An electromagnet 35 works in opposition to spring pressure and closes the safety valve 33, when a corresponding current flows through the winding of the electromagnet. When the control unit 28 switches off the current, or when the current fails, the safety valve 33 will automatically return to the short-circuit position, whereby steerability of the vehicle is guaranteed.

The subassembly, which regulates the amount and the direction of the working pressure, including the safety valve 33, is briefly referred to as valve assembly 30 and is drawn in broken lines in FIG. 1.

A pressure sensor 41a, 41b is respectively connected to the cylinder chambers 21, 22 in terms of flow in order to measure the respective pressure in the cylinder chambers, which is referred to as actuator pressure in the following. The respective pressure in the left or right cylinder chamber is designated by p_{AK,LI} and p_{AK,RE}, respectively, in FIG. 1. The output signals of the pressure sensors 41a, 41b, p_{AK,LI} and p_{AK,RE}, are sent as input signals to the control unit 28 by way of control conduits 42a, 42b. As another input signal, the control unit 28 receives the vehicle speed and v_{Kfz}, because the performance of the vehicle steering system, among other factors, also depends on the vehicle speed. Ultimately, the electronic control unit also receives a signal U_{bat} in order to trigger a fault report, as the case may be, if the battery voltage U_{bat} drops below a defined threshold value and the proper functioning of the vehicle steering system is ensured no longer. The effect of a fault report is that the safety valve 33 is switched off and a hydraulic short-circuit is constituted between the cylinder chambers 21, 22, deactivating the hydraulic steering aid.

FIG. 2 illustrates the valve assembly 30 in more detail still. In particular, FIG. 2 shows the slide valve 43, which is operated by an electromagnet 44. Valve 43 functions as a pressure control valve and controls the servo pressure that is applied to the working cylinder 19. A travel sensor 45 measures the position of the slide of the pressure control valve 43 or the position of the electromagnet, respectively.

In the embodiment illustrated in FIG. 2, the electromagnet 44 acts in opposition to a mechanical spring. In another embodiment, however, two electromagnets and two springs may be provided just as well, which are arranged at opposite sides of the displacement travel. In still another embodiment, a corresponding gear can drive the slide valve 43 electromotively. The manner how the slide valve is driven is of no importance for the invention at topic. Therefore, reference will be made hereinbelow commonly to an actuator, whose position is undoubtedly related to the position of the slide of the valve. The position of the slide of the valve 43 in turn clearly defines the magnitude of the servo pressure.

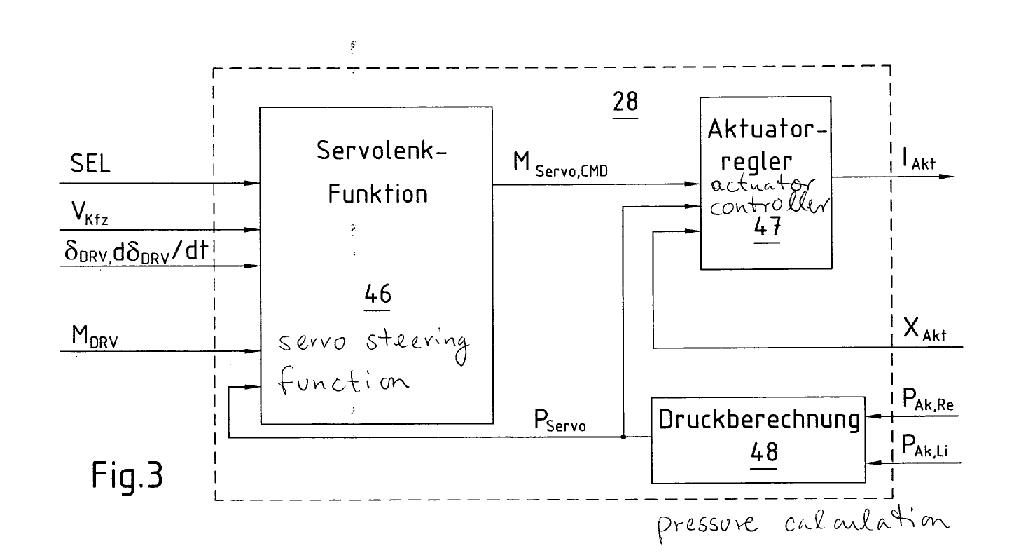

The functions of the previously described vehicle steering system will now be explained in detail, making reference to FIGS. 3 to 8.

The function of the control unit 28 shown in FIG. 1 is subdivided into main function blocks in FIG. 3. Among these main function blocks is a servo steering function 46, an actuator controller 47, and a function module 48 for calculating the servo pressure. In the function module ‘servo steering function’ 46, the servo moment for the driver is determined depending on the driver's hand moment M_{DRV}, the steering wheel angle δ_{DRV}, the steering wheel angular velocity dδ_{DRV}/dt and the vehicle speed v_{Kfz}, and it is transmitted as a nominal value M_{Servo,CMD} for the servo steering torque to the subordinated actuator controller 47 in an embodiment of the invention.

In non-illustrated embodiments of the invention, a nominal servo pressure p_{Servo,CMD} that corresponds to the nominal value M_{Servo,CMD} can equally be sent from the function module 46 to the actuator controller 47. The nominal servo torque M_{Servo,CMD} and the nominal servo pressure are proportional to one another in this case.

The servo torque M_{Servo,CMD} is calculated in the function module 46 on the basis of essentially known partial functions such as parameter steering, active steering resetting, centering, etc., which are known in the state of the art and are not covered by the subject matter of the invention. In addition, another input signal SEL renders it possible to select different characteristics and functions in the function module 46. This way, a selection of different types of steering performance can be offered to the driver.

The function module 48 ‘pressure calculation’ calculates from the output signals p_{AK,RE} and p_{AK,LI} of the pressure sensors 41a, 41b (FIG. 1) the instantaneously prevailing servo pressure p_{Servo}. The calculated servo pressure p_{Servo} is conveyed to the function modules 46 and 47. In addition, the actuator controller 47 receives a position signal x_{Akt} indicating the position of the slide of the pressure control valve 43 or of the actuator, respectively. The actuator controller 47 calculates from the input quantities M_{Servo,CMD}, p_{Servo} and x_{Akt} an output signal I_{AKT}, which is representative of the magnitude and direction of an electric current for operation of the actuator. This signal initially prevails as a digital signal, and is converted in a known manner into an analog actuating signal and is amplified in order to drive an electromagnetic or electromotive actuator. The actuator readjusts the position of the slide in the pressure control valve and thus regulates the pressure of the hydraulic servo aid in order to achieve the desired steering aid.

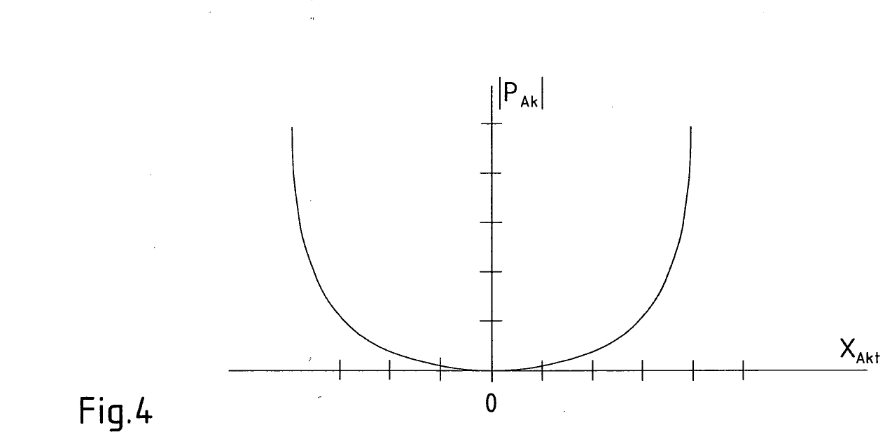

In the actuator control, the invention takes the characteristics of the slide valve into account, which is used for pressure control, wherein relatively large regulating distances of the slide cause only insignificant pressure variations in the range of low pressures. In contrast thereto, relatively short regulating distances of the slide cause major pressure variations in the range of high pressures. This performance is illustrated by the characteristic curve shown in FIG. 4. The regulating distance of the slide x_{Akt} is plotted on the abscissa, and the pressure variation P_{Ak} achieved thereby is plotted on the ordinate. It becomes obvious in this illustration that the slide valve exhibits a soft performance in the range of low pressures, becoming stiffer with increasing pressures.

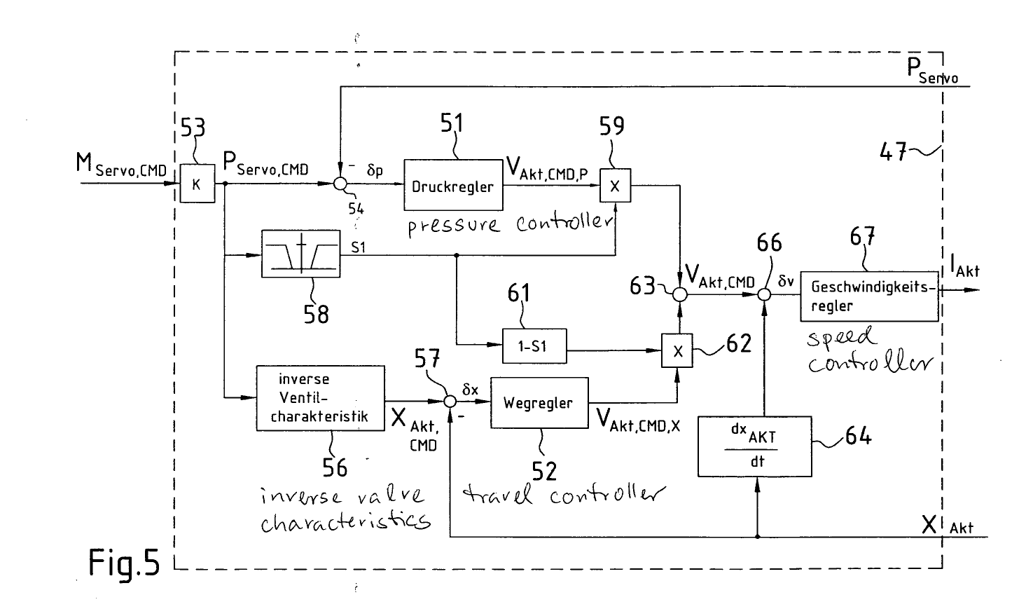

The actuator control 47 of FIG. 3 is shown in more detail in FIG. 5. The actuator control 47 is a parallel combination of a pressure controller 51 and a travel controller 52. In a conversion function block 53, the servo torque M_{Servo,CMD} calculated by the function module 46 is converted into a nominal servo pressure p_{Servo,CMD}, and the instantaneous servo pressure p_{Servo} calculated by the function module 48 is deducted therefrom in a difference stage 54.

The conversion function block 53 is omitted in embodiments of the invention where the function module 46 provides already the nominal servo pressure p_{Servo,CMD}.

The difference signal δp forms the input signal for the pressure controller 51 determining therefrom a first actuator corrective signal v_{Akt,CMD,p}. A nominal position x_{Akt,CMD} is determined from the nominal servo pressure p_{Servo,CMD} determined in the conversion function block 53 in an evaluation step 56 with the aid of a model for the inverse valve characteristics of the pressure control valve. FIG. 4 shows the valve characteristics on which this calculation is based. The actual position x_{Akt} measured by the travel sensor 45 is deducted from the nominal position of the actuator x_{Akt,CMD} in a difference stage 47. The difference signal δx represents the input signal for the travel controller 52. From the input signal δx, the travel controller 52 determines a second corrective signal v_{Akt,CMD,x} for the actuator. Both controllers 51, 52 are active at any time in this arrangement and generate corrective signals.

Depending on the desired nominal servo pressure p_{Servo,CMD}, a selection unit 58 defines a weighting factor S1, with which the output signal of the pressure controller 51 is weighted in a multiplication stage 59. A second weighting factor S2 is determined from the first weighting factor S1 in a calculation stage 61 according to the equation

S2=1−S1.

The output signal v_{Akt,CMD,x} of the travel controller 52 is multiplied by the second weighting factor S2 in a multiplication stage 62. In an addition stage 63, the two weighted corrective signals of the pressure controller 51 and the travel controller 52 are added in order to obtain a joint corrective signal v_{Akt,CMD}. The joint corrective signal v_{Akt,CMD} corresponds to an actuating speed of the actuator. A differentiating stage 64 calculates the instantaneous actuator speed dx_{Akt}/dt from the cyclically measured position signals x_{Akt} of the actuator. The instantaneous actuator speed is subtracted from the joint corrective signals v_{Akt,CMD} in a difference stage 66 in order to obtain a difference signal δv. A speed controller 67 produces from the difference signal δv an output signal I_{Akt}, which represents an electric current for the operation of the actuator.

In the range of low pressures, the travel controller is essentially or even exclusively in engagement (S1=0 or S1 is very low) for reasons of meterability of the pressure and the improved dynamics, the travel controller permitting a defined positioning of the valve slide for pressures close to zero bar in addition. In terms of structure, this controller is preferred to be a controller with a proportionally acting performance (P-controller), and the boosting factor can be adapted to the valve characteristic curve in a preferred embodiment. In contrast thereto, a very stiff system performance is encountered in the range of high pressures so that insignificant changes of travel cause major pressure variations. In this respect, the pressure controller is suited better and, therefore, is in engagement (S1=1 or close to 1, however, inferior to 1). The reasons can be seen again in the good meterability in the range of high pressures, the optimal utilization of the available pressure increase dynamics and an improved stationary accuracy in controlling the servo pressure. As a controller for the pressure controller, it is preferred to employ a controller with a proportional and differentiating performance (PD-controller), and the proportional part can also be adapted to the valve characteristics.

As can be seen in the characteristic curve of the parameter unit 58 illustrated in FIG. 5, there is a range of transition in which both controllers are in engagement with approximately equal weights. The weighting factors S1 and S2 have an approximate value of 0.5 in his range. The speed nominal values v_{Akt,CMD,P} and v_{Akt,CMD,x} of both controllers multiplied by the weighting factor are added to a resulting speed nominal value for the subordinate speed controller 67 showing a proportional and integrating performance (PI-controller). The output quantity of the controller 67 is a nominal value for the electric current being adjusted that feeds the actuator.

In a modified embodiment of the invention, a function module that is not shown in FIG. 5 can be provided to monitor and limit the valve slide travel in order to prevent movement against the slide's mechanical abutment.

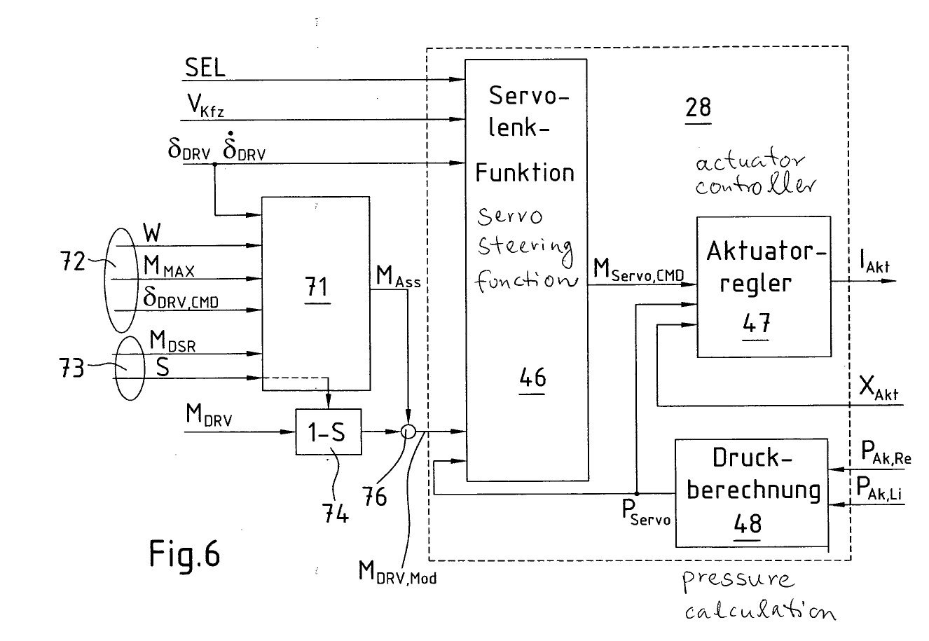

FIGS. 6 to 8 shown schematic action charts, which illustrate how it is possible to use and adjust controlling interventions of an overriding driver assistance system in the vehicle steering system of the invention.

FIG. 6 shows an action chart, wherein controlling interventions such as a steering torque or a steering angle are predetermined by an overriding control system, which is not illustrated herein. This control system can e.g. be a tracking system, a parking aid system, or a driving stability system (for example, ESP with steering torque corrective intervention). In the illustration of FIG. 6, these steering interventions or the torques resulting therefrom are interpreted as driver specifications and, together with the driver hand moment of the servo steering function, are transmitted in the form of a modified driver torque. For the sake of simplicity, it shall be assumed that only one single driver assist system is provided.

The control system for the vehicle steering illustrated in FIG. 6 substantially comprises the already described control unit 28 and a linking module 71, which provides two universal interfaces for driver assist systems intervening into the vehicle steering system, i.e. a steering angle interface 72 and a steering torque interface 73. At the steering angle interface 72, the linking unit 71 receives a steering angle δ_{DRV,CMD} predefined by the driver assist system, a maximum allowable steering torque M_{Max}, and a danger signal W, the function of which will be explained hereinbelow.

At the steering torque interface 73, the linking unit 71 receives a steering torque request of the driver assist system M_{DSR} and a control variable S, which can assume the values 0 or 1 and with which the torque request of the driver assist system M_{DSR} is weighted. The control variable S is also conveyed to a processing stage 74, where the steering torque requested by the driver is multiplied by a factor 1-S. Thus, this control variable S allows setting whether the torque request of the driver assist system M_{DSR} is additively superposed on the torque M_{DRV} requested from the driver (S=0) or shall be used instead of this signal (S=1). The linking unit 71 determines from all input signals a resulting total assist steering torque M_{ASS}, which is added in an adder 76 to the torque M_{DRV} requested by the driver to a total torque M_{DRV,Mod}.

Thus, the total torque M_{DRV,Mod} takes the place of the pure driver torque M_{DRV}. The function of the danger signal W is to generate vibrations in the steering wheel when the driver assist system intervenes into the vehicle system in order to terminate a critical driving situation, for example. The purpose of the vibrations of the steering wheel is to make the driver aware of the intervention of the driver assist system, e.g. in order to alert him by means of these alarm vibrations to the impending leaving of the track.

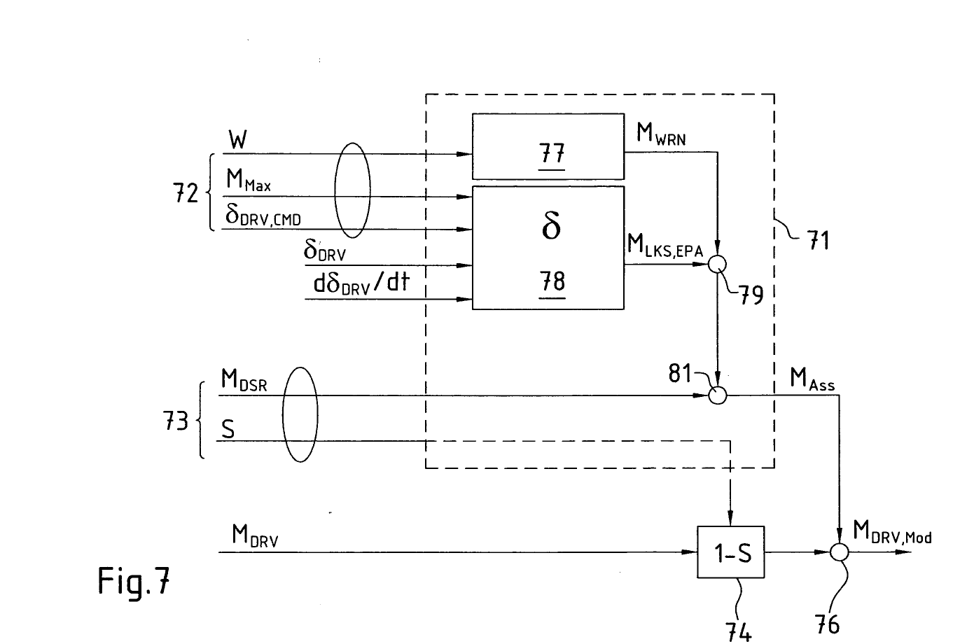

FIG. 7 shows in a detailed view the linking module 71 for processing the nominal value requests of the driver assist system. It becomes obvious from FIG. 7 that the linking module 71 is essentially composed of a vibration generator 77 and a steering angle control 78 and two adders 79, 81. The vibration generator 77 generates an oscillating steering torque M_{WRN}, which can be felt at the steering wheel 1 (FIG. 1) when a danger signal W prevails. The steering angle control generates a steering torque M_{LKS,EPA} corresponding to the steering angle input quantities. The two steering torques M_{WRN} and M_{LKS,EPA} are added in the adder 79 and are ultimately joined in the adder 81 with the steering torque M_{DSR} in order to produce the total assist steering torque M_{ASS} of the linking module 71. As has been described already with regard to FIG. 6, the total assist steering torque M_{ASS} is added to the driver steering torque M_{DRV} in the adder 76 in consideration of the control variable S. The output signal of the adder 76 is the modified driver steering torque M_{DRV,Mod}, which is further processed in the function module 46 in the way described with reference to FIG. 6.

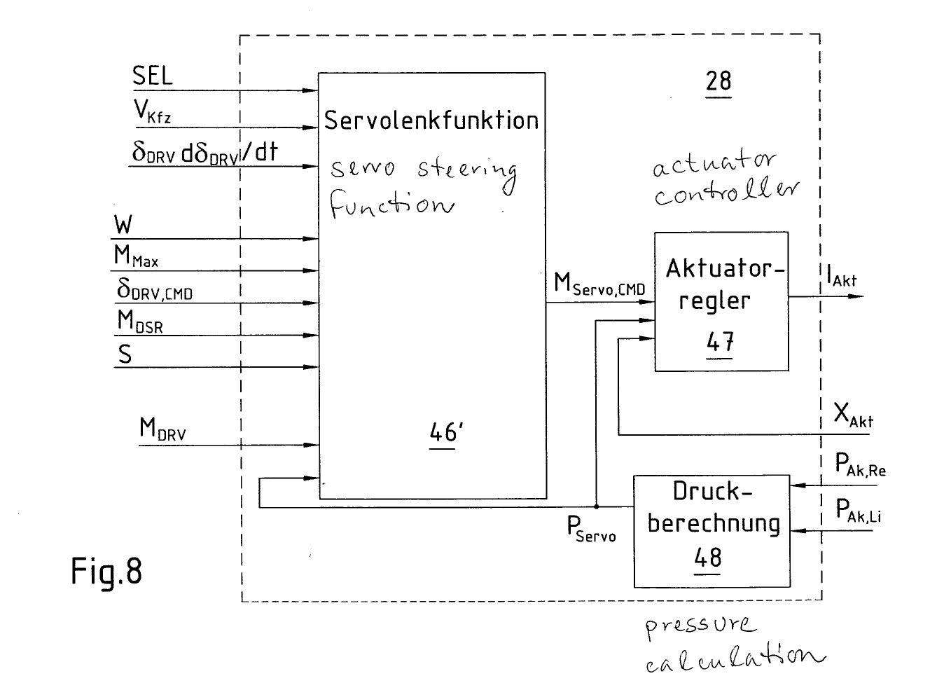

FIG. 8 shows a modified embodiment of the invention with a higher degree of integration. The functions, which are associated with the linking module 71 in the embodiment of FIG. 6, have been integrated herein into a modified function module 46′.

1-16. (canceled)

17. A vehicle steering system for a motor vehicle having a steering handle (1) operable by a driver and connected to steerable vehicle wheels (10, 11) in terms of effect to determine a direction of driving, the system comprising:
a hydraulic working cylinder (19) having two directions of effect;
a hydraulic pressure source (12) which applies hydraulic pressure to a valve assembly (30), the valve assembly (30) controlling a magnitude of the hydraulic pressure conveyed to the working cylinder (19) and determining a direction of effect of the working cylinder, wherein the valve assembly (30) has a slide valve (43), which is actuated by an actuator (44) and associated with which are a pressure sensor (41a, 41b) and a travel sensor (45), whose signal outlets are connected to a pressure controller (51) or a travel controller (52) in terms of signals, and an output quantity of the pressure controller and of the travel controller can be sent to an evaluating circuit (59, 62), which links the output quantities to weighting factors in order to determine a controlled quantity of the actuator.

18. A vehicle steering system according to claim 17, wherein the actuator (44) is an electromagnetic or an electromotive actuator.

19. A method of controlling a hydraulic vehicle steering system, wherein a servo pressure is adjusted during a steering movement by means of an electromotively or electromagnetically driven valve (43), the method comprising:
detecting instantaneous pressures (P_{AK,Re}; P_{AK;LI}) in cylinder chambers (21; 22) of a working cylinder (19);
detecting a position (X_{Akt}) of a control member (43) for adjusting the servo pressure (P_{Servo});
determining an actuation parameter (V_{Akt,CMD,X}) for the control member (43) on the basis of the detected working pressure (P_{Servo}) and a nominal servo pressure (P_{Servo,CMD});
determining an actuation parameter (V_{Akt,CMD,X}) for the control member on the basis of the detected position (X_{Akt}) of the control member and a nominal value (X_{Akt,CMD}) for the position of the control member (43);
defining weighting factors (S1, S2) for the actuation parameters (V_{Akt,CMD,p}; V_{Akt,CMD,X}) as a function of the nominal servo pressure (P_{Servo,CMD}), and calculating a joint actuation parameter (V_{Akt,CMD}) from the weighted actuation parameters.

20. A method according to claim 19, wherein in the presence of low servo pressures (P_{Servo,CMD}), the weighting factors are adjusted in such a manner that the actuation parameter (V_{Akt,CMD,X}), which was found based on the detected position (X_{Akt}) of the control member (43), dominates the joint actuation parameter (V_{Akt,CMD}).

21. A method according to claim 19, wherein the weighting factors are adjusted in such a fashion in the presence of high servo pressures (P_{Servo,CMD}) that the actuation parameter (V_{Akt,CMD,p}), which was detected on the basis of the nominal servo pressure (P_{Servo,CMD}), dominates the joint actuation parameter.

22. A method according to claim 19, wherein the weighting factors (S1, S2) in the interval range from 0 to 1.

23. A method according to claim 19, wherein a sum of the weighting factors (S1, S2) equals 1.

24. A method according to claim 19, wherein a nominal torque (M_{Servo,CMD}) for the hydraulic vehicle steering system is calculated from commands of the driver (δ_{DRV}, M_{DRV}, d δ_{DRV}/dt).

25. A method according to claim 24, wherein output signals of driver assist systems (δ_{DRV,CMD}; M_{DSR},W) are superposed on the driver's commands.

26. A method according to claim 25, wherein the output signals of driver assist systems are additively superposed on the driver's commands.

27. A method according to claim 25, wherein the output signals of driver assist systems are superposed on the driver's commands with a weighting factor (S).

28. A method according to claim 25, wherein the driver's commands and the output signals of driver assist systems are conveyed to a function module (46; 46′) in which the nominal torque (M_{Servo,CMD}) for the hydraulic vehicle steering system is determined depending on the driver's commands and the output signals of the driver assist systems.

29. A method according to claim 24, wherein a steering torque is determined from the output signals of driver assist systems (δ_{DRV,CMD}, W), or the steering torque (M_{DSR}) is provided by driver assist systems.

30. A method according to claim 29, wherein the steering torques determined from the output signals of driver assist systems and/or the steering torques provided by driver assist systems are superposed additively to achieve a total assist steering torque (M_{ASS}), which is used to determine the nominal torque (M_{Servo,CMD}) for the hydraulic vehicle steering system.

31. A method according to claim 30, wherein the total assist steering torque is sent to the function block (46) in order to determine the nominal torque (M_{Servo,CMD}) for the hydraulic vehicle steering system.

32. A method according to claim 31, wherein the total assist steering torque (M_{ASS}) is additively superposed on a driver steering torque (M_{DRV}) to achieve a modified driver steering torque (M_{DRV,Mod}), which is sent to the function block (46) in order to determine the nominal torque (M_{Servo,CMD}) for the hydraulic vehicle steering system and which is taken into account to determine the nominal torque (M_{Servo,CMD}) for the hydraulic vehicle steering system.
